(19) United States
(12) Patent Application Publication
(10) Pub. No.: US 2006/0267322 A1
(43) Pub. Date: Nov. 30, 2006

(54) Apparatus for inflating an inflatable vehicle occupant restraint

(75) Inventor: Eric J. Eckelberg, Macomb, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems Inc.

(21) Appl. No.: 11/137,918

(22) Filed: May 26, 2005

(51) Int. Cl. B60R 21/26

(52) U.S. Cl. 280/736; 280/735

(57) ABSTRACT

An apparatus (10) for inflating an air bag (12) includes a first source (22) of inflation fluid actuatable to produce a volume of inflation fluid and a second source (24) of inflation fluid actuatable to produce a volume of inflation fluid. The apparatus (10) also includes a temperature sensor (72) for providing a temperature signal indicative of the temperature of the apparatus (10) and a control system (50) operatively connected to the temperature sensor (50). The control system (50) actuates the first and second sources (22, 24) of inflation fluid. The apparatus (10) further includes a delay circuit coupled (51) to the temperature sensor (72) and the control system (50). The delay circuit (51) is responsive to the temperature signal for delaying the actuation of one of the first and second sources (22, 24) for a predetermined period of time after actuation of the other one of the first and second sources (22, 24).

### TECHNICAL FIELD

The present invention relates to an apparatus for inflating an inflatable vehicle occupant restraint such as an air bag.

### BACKGROUND OF THE INVENTION

An apparatus for inflating an inflatable vehicle occupant restraint, such as an air bag, includes an inflator which comprises a source of inflation fluid for inflating the air bag. The source of inflation fluid may include, for example, an ignitable gas generating material which generates a large volume of gas when ignited. When the vehicle experiences deceleration indicating the occurrence of a vehicle collision, the gas generating material is ignited. The fluid that is generated by combustion of the gas generating material is directed from the inflator into the air bag to inflate the air bag. When the air bag is inflated, it extends into the vehicle occupant compartment for helping to protect an occupant of the vehicle.

It is sometimes desirable to control the inflation of the air bag in response to various conditions. For example, it may be desirable to control the inflation of the air bag in response to the ambient temperature. One apparatus disclosed by U.S. Pat. No. 5,460,405 includes a plurality of sources of inflation fluid in which one or more of the sources of inflation fluid are actuated in response to various conditions. When inflating the bag using more than one inflation source, it may be desirable to delay the operation of one of the sources in response to the ambient temperature.

### SUMMARY OF THE INVENTION

The present invention relates to an apparatus for inflating an air bag that includes a first source of inflation fluid actuatable to produce a first volume of inflation fluid and a second source of inflation fluid actuatable to produce a second volume of inflation fluid which differs from the first volume. The apparatus also includes a temperature sensor for providing a temperature signal indicative of the temperature of the apparatus and a control system operatively connected to the temperature sensor. The control system actuates the first and second sources of inflation fluid. The apparatus further includes a delay circuit coupled to the temperature sensor and the control system. The delay circuit is responsive to the temperature signal for delaying the actuation of one of the first and second sources for a predetermined period of time after actuation of the other one of the first and second sources.

According to another aspect, the present invention relates to an apparatus for inflating an air bag inflator that includes a first source of inflation fluid actuatable to produce a volume of inflation fluid and a second source of inflation fluid actuatable to produce a volume of inflation fluid. The apparatus also includes a temperature sensor for providing a temperature signal indicative of the temperature of the apparatus and a control system operatively connected to the temperature sensor. The control system actuates the first and second sources of inflation fluid. The apparatus further includes a delay circuit coupled to the temperature sensor and the control system. The delay circuit delays the actuation of one of the first and second sources for a predetermined period of time after actuation of the other one of the first and second sources based on the temperature signal. The predetermined period of time equals 10 milliseconds+(1 millisecond/(Inflator ambient temperature degree centigrade −22° C.)) for inflator ambient temperatures above 22° C.

### BRIEF DESCRIPTION OF THE DRAWINGS

Preferred embodiments of the present invention are illustrated in the accompanying drawings in which:

FIG. 1 is a schematic view of a vehicle occupant restraint system constructed in accordance with a first embodiment of the present invention;

FIG. 2 is a schematic view of parts of the system of FIG. 1;

FIG. 3 is a schematic illustration of a second embodiment of the present invention and includes a sectional view of the inflator; and

FIG. 4 is a view taken along line 4-4 in FIG. 3.

### DETAILED DESCRIPTION OF THE INVENTION

A vehicle occupant restraint system 10 constructed in accordance with a first embodiment of the present invention is shown schematically in FIG. 1. The vehicle occupant restraint apparatus 10 includes an inflatable vehicle occupant restraint 12, commonly referred to as an air bag, for restraining movement of a vehicle occupant upon the occurrence of a vehicle collision. The air bag 12 is stored in the vehicle at a location adjacent to the vehicle occupant compartment 14. If the air bag 12 is to restrain forward movement of a vehicle occupant upon the occurrence of a collision, the air bag 12 is stored adjacent to the front of the vehicle occupant compartment 14, such as in the steering wheel of the vehicle or in the instrument panel of the vehicle. If the air bag 12 is to restrain movement of the vehicle occupant toward a side of the vehicle upon the occurrence of a collision, the air bag 12 is stored adjacent to the side of the vehicle occupant compartment 14, such as in a door of the vehicle.

When the vehicle experiences deceleration indicating the occurrence of a collision, the air bag 12 is inflated from a stored condition, shown schematically in FIG. 1, to an inflated condition. When the air bag 12 is in the inflated condition, it extends into the vehicle occupant compartment 14 to help restrain movement of an occupant of an adjacent vehicle seat 16. A cover 18 conceals the air bag 12 from the vehicle occupant compartment 14 when the air bag 12 is in the stored condition. The cover 18 opens during inflation of the air bag 12 from the stored condition to the inflated condition.

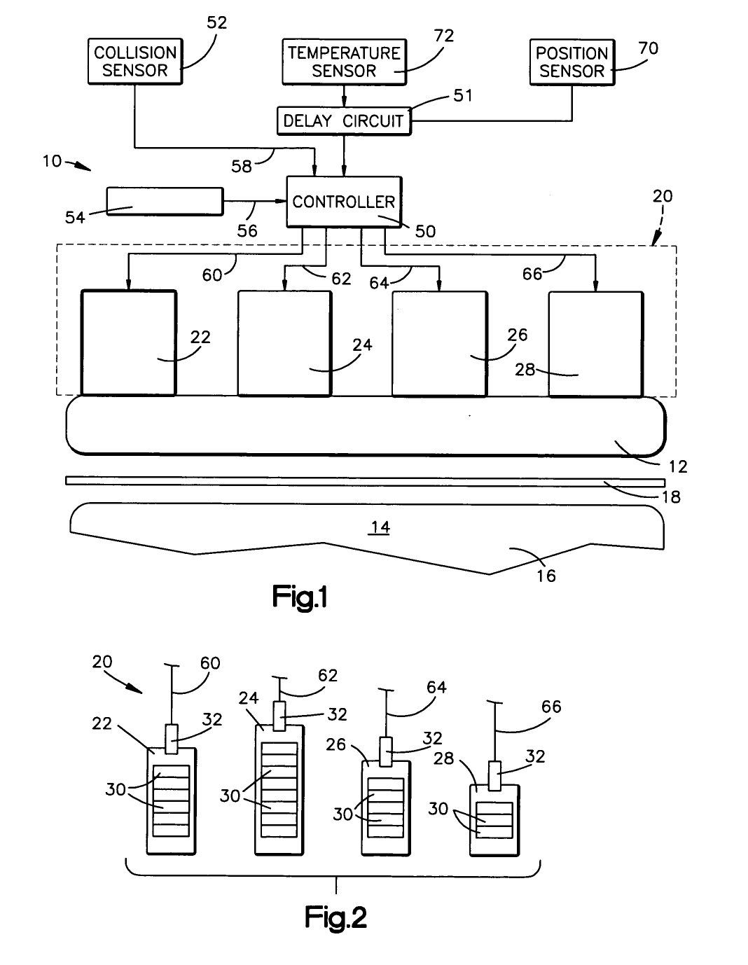

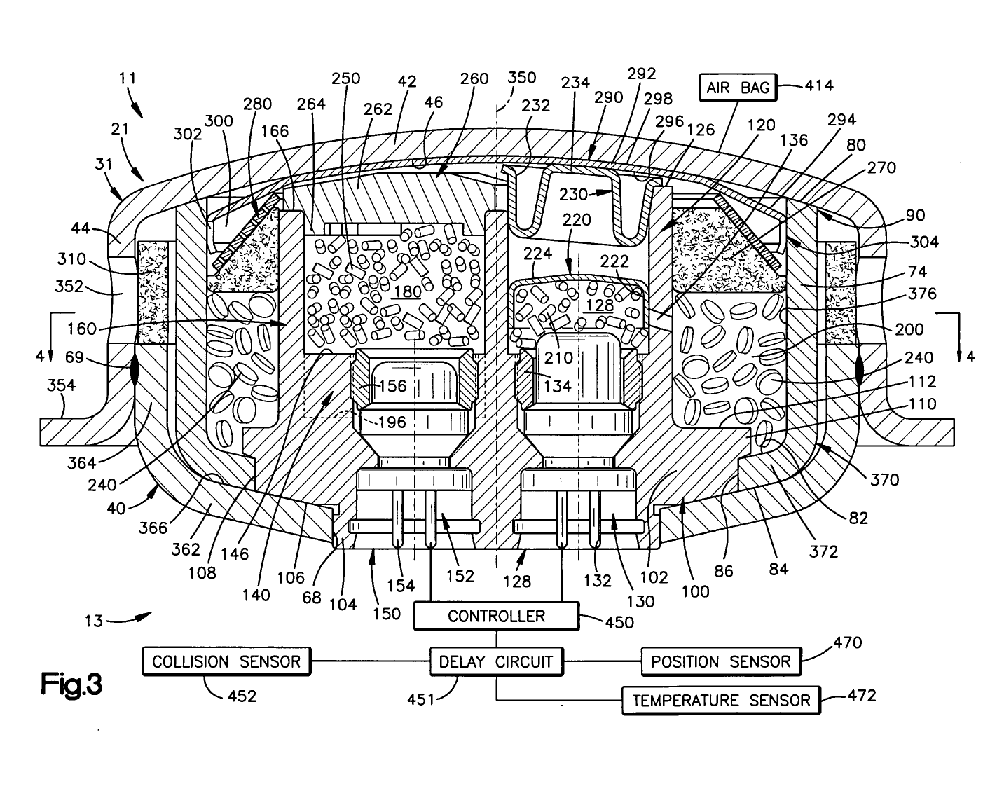

The vehicle occupant restraint apparatus 10 also includes an inflator assembly 20 for providing inflation fluid for inflating the air bag 12. The inflator assembly 20 includes a plurality of sources of inflation fluid that are actuatable separately and independently from each other. In the embodiment of the present invention shown in FIG. 1, the inflator assembly 20 includes four sources 22, 24, 26 and 28 of inflation fluid. As shown in FIG. 2, each of the four sources 22, 24, 26, and 28 of inflation fluid comprises a plurality of grains 30 of ignitable gas generating material. The material of which the grains 30 are formed produces a large volume of gas when ignited, and may have any suitable composition known in the art. Each of the four sources 22, 24, 26, and 28 of inflation fluid further comprises a respective squib 32 that, when actuated, ignites the respective grains 30 of gas generating material. Such squibs 32 also are known in the art.

The inflator assembly 20 also includes at least two sources of inflation fluid that provide respective volumes of inflation fluid that differ from one another. Preferably, each of the four sources 22, 24, 26, and 28 of inflation fluid provides a respective volume of gas which differs from the respective volume of gas provided by each other of the four sources of inflation fluid. Accordingly, the number of grains 30 of gas generating material in each of the four sources 22, 24, 26, and 28 of inflation fluid is different, as shown in FIG. 2.

The vehicle occupant restraint apparatus 10 further includes an electronic controller 50 and a collision sensor 52. The controller 50 preferably comprises a microprocessor of known construction, and is connected with a suitable power source 54 through a line 56. If the air bag 12 is stored at the front of the vehicle, the collision sensor 52 preferably comprises an acceleration sensor that senses acceleration along a front-to-rear axis of the vehicle. If the air bag 12 is stored at the side of the vehicle, the collision sensor 52 preferably comprises an acceleration sensor that senses acceleration along a side-to-side axis of the vehicle, or alternatively, comprises a crush sensor. When the collision sensor 52 senses the vehicle condition that indicates the occurrence of a collision requiring inflation of the air bag 12, the controller 50, which receives signals from the collision sensor via line 58, responds by actuating one or more of the sources 22, 24, 26, and 28 of inflation fluid.

Specifically, the controller 50 communicates with the first source 22 through a first actuator line 60, and separately and independently communicates with each of the second, third and fourth sources 24, 26 and 28 through second, third and fourth actuator lines 62, 64 and 66, respectively. When the first source 22 of inflation fluid is to be actuated, the controller 50 provides a first actuation signal to the first source 22 via the first actuator line 60. The squib 32 (FIG. 2) of the first source 22 is then actuated. As a result, the grains 30 of gas generating material in the first source 22 are ignited to generate a first volume of gas for inflating the air bag 12. Each of the second, third, and fourth sources 24, 26 and 28 of inflation fluid is actuatable in the same manner by a second, third or fourth actuation signal, respectively, provided by the controller 50 on the second, third or fourth actuator line 62, 64 or 66. Second, third or fourth volumes of gas are then generated accordingly.

The controller 50 may actuate any number of the four sources 22, 24, 26, and 28 of inflation fluid in response to the collision signal received from the collision sensor 52. The controller 50 may also actuate any number of the four sources 22, 24, 26, and 28 of inflation fluid either simultaneously or in sequence. The controller 50 may thus actuate the sources 22, 24, 26, and 28 of inflation fluid in any one of a plurality of modes of operation which differ from each other in the number and/or the timing of the sources 22, 24, 26, and 28 being actuated. The volumes of inflation fluid that are provided in the differing modes of operation will differ accordingly. The mode in which the sources 22, 24, 26, and 28 of inflation fluid are actuated by the controller 50 is responsive to information received from a position sensor 70 and a temperature sensor 72.

The position sensor 70 senses the position of the seat 16 relative to the part of the vehicle in which the air bag 12 is stored and provides a position signal indicative of the sensed position. The position of the seat 16 affects the position of an occupant of the seat 16 relative to the air bag 12. Therefore, the position signal provided by the position sensor 70 is also indicative of the position of an occupant of the seat 16 relative to the air bag 12. If the position of the occupant of the seat 16 is indicated to be relatively close to the air bag 12, it may be desirable to inflate the air bag 12 relatively slowly and/or to a relatively small inflated volume, i.e., to provide a relatively “soft” inflation of the air bag 12. This can be accomplished, for example, by actuating less than all of the four sources 22, 24, 26, and 28 of inflation fluid and/or by actuating a number of the sources sequentially rather than simultaneously. Although the position sensor 70 has been described as sensing the position of the seat 16, the position sensor may directly sense the position of the occupant of the seat.

The temperature sensor 72 senses the ambient temperature at the inflator assembly 20 and provides a temperature signal indicative of the sensed ambient temperature. The ambient temperature at the inflator assembly 20 affects the rate at which the grains 30 of gas generating material burn to generate gas for inflating the air bag 12. If the ambient temperature is very low, it may be desirable to actuate all of the sources 22, 24, 26, and 28 of inflation fluid to ensure that a sufficient volume of gas is generated in the time required for inflation of the air bag 12. Alternatively, if the ambient temperature is very high, it may be desirable to actuate only one of the sources 22, 24, 26, and 28 of inflation fluid, because one of the sources 22, 24, 26, and 28 alone may provide the required volume of gas as a result of a more rapid combustion of the grains 30 which occurs at the higher ambient temperature.

The system of FIG. 1 also includes a delay circuit 51, such as a solid state time delay circuit or any other known time delay circuit or device. The delay circuit 51 is electrically coupled to the controller 50 and to the position and temperature sensors 70, 72. Alternatively, the delay circuit 51 may form a portion of the controller 50. The delay circuit 51 is responsive to the temperature signal and the pressure signal for delaying actuation of one of the sources 22, 24, 26, and 28 for a predetermined time period after actuation of one of the other sources. In the embodiment of FIG. 1, the delay circuit 51 may be used to delay the actuation of the second source 24 after the actuation of the first source 22, delay the actuation of the third source 26 after actuation of the second source 24, and delay the actuation of the fourth source 28 after the actuation of the third source 26.

When two sources, for example, sources 22 and 24, are actuated sequentially to inflate the air bag 12, a predetermined time period of the delay is 10 milliseconds+(1 millisecond/(Inflator ambient temperature in degree centigrade −22° C.)) for inflator ambient temperatures above 22° C. For temperatures less than or equal to 22° C., the predetermined time period of the delay is 10 milliseconds. The rate of inflation of the air bag rises as the ambient temperature of the inflator rises. Thus, increasing the delay when the ambient temperature increases above 22° C. counteracts the increase in the rate of inflation of the air bag due to the rise in ambient temperature.

The delay circuit 51 is responsive to the position signal for modifying the time period of the delay. For example, if the position of the occupant of the seat 16 is indicated as being relatively close to the air bag 12, it may be desirable to increase the delay to inflate the air bag 12 relatively slowly to provide a relatively “soft” inflation of the air bag. The delay circuit 51 can also be responsive to other sensors such as those that determine the size and weight of an occupant for further modifying the time period of the delay. The predetermined time period of the delay between the actuation of first and second sources does not exceed 30 milliseconds.

The controller 50 is responsive to the delay circuit signals received from the delay circuit 51 for providing actuation signals on the first, second, third and/or fourth actuator lines 60-66 in such a manner as to actuate a desired number of the sources 22, 24, 26, and 28 of inflation fluid, either sequentially or simultaneously. The controller 50 is thus responsive to the temperature signal and the position signal for actuating the sources 22, 24, 26, and 28 of inflation fluid in a mode of operation that inflates the air bag 12 efficiently at the particular ambient temperature of the inflator assembly 20 and the indicated position of the occupant.

If the controller 50 actuates less than all of the sources 22, 24, 26 and 28 of inflation fluid for inflating the air bag 12, the remaining sources are always actuated within 100 milliseconds after the occurrence of the vehicle collision to prevent inadvertent activation of the remaining sources long after the occurrence of the vehicle collision.

FIG. 3 discloses a vehicle occupant restraint apparatus 13 constructed in accordance with a second embodiment of the present invention. The vehicle occupant restraint apparatus 13 includes a dual stage air bag inflator 11. The apparatus 13 also includes a collision sensor 452 that senses a vehicle condition that is indicative of the occurrence of a vehicle collision. If the vehicle condition sensed by the collision sensor 452 is at or above a first predetermined threshold level, it indicates the occurrence of a crash having a first level of severity. The first level of severity is a level at which inflation of an air bag 414 at a relatively low rate is desired for protection of a vehicle occupant. If the vehicle condition sensed by the collision sensor 452 is at or above a second predetermined threshold level, it indicates the occurrence of a crash having a second, higher level of severity. The second level of severity is a level at which inflation of the air bag 414 at a relatively high rate is desired for protection of a vehicle occupant.

The collision sensor 452 is coupled to a controller 450. The controller 450 is coupled to the inflator 11. At the occurrence of a crash, the collision sensor 452 sends a signal to the controller 450. The controller 450 is responsive to the signal for actuating the inflator 11.

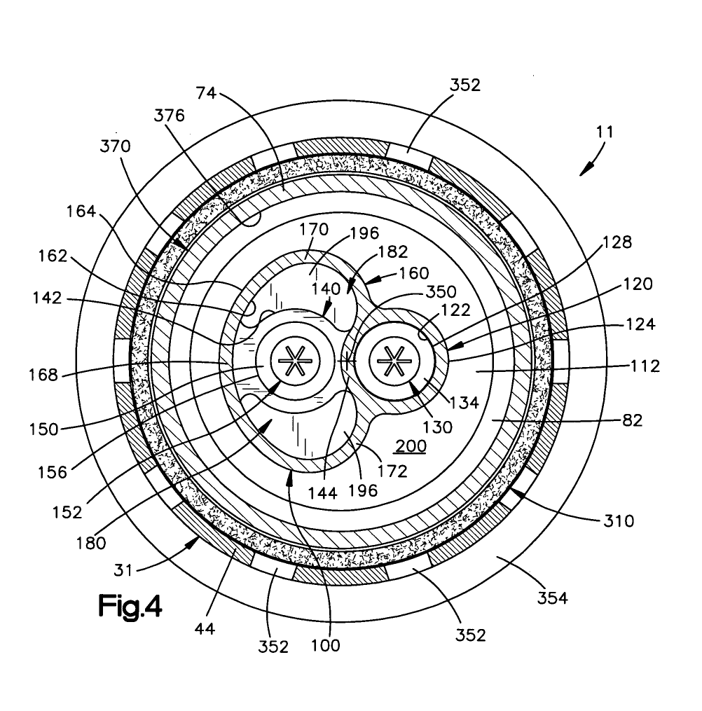

The inflator 11 includes a generally cylindrical housing or shell 21. The inflator 11 has a circular configuration as viewed from above in FIG. 3 (as shown in FIG. 4). The housing 21 includes a first or upper (as viewed in FIG. 3) housing part 31, referred to herein as a diffuser, and a second or lower (as viewed in FIG. 3) housing part 40, referred to herein as a closure.

The diffuser 31 has an inverted, cup-shaped configuration centered on an axis 350 of the inflator 11. The diffuser 31 includes a radially extending end wall 42 and an axially extending side wall 44. The end wall 42 of the diffuser 31 is domed, that is, has a curved configuration projecting away from the closure 40. The end wall 42 has an inner side surface 46.

The side wall 44 of the upper housing part 31 has a cylindrical configuration centered on the axis 350. Multiple inflation fluid outlets 352 are disposed in a circular array on the side wall 44. Each one of the inflation fluid outlets 352 extends radially through the side wall 44. The outlets 352 enable flow of inflation fluid out of the inflator 11 to inflate the air bag 414. The outlets 352, as a group, have a fixed, predetermined flow area. An annular inflator mounting flange 354 extends radially outward from the side wall 44 at a location below (as viewed in FIG. 3) the inflation fluid outlets 352.

The closure 40 has a cup-shaped configuration including a radially extending end wall 362 and an axially extending side wall 364. The end wall 362 of the closure 40 is domed, that is, has a curved configuration projecting away from the upper housing part 31. The end wall 362 has an inner side surface 366 presented toward the end wall 42 of the upper housing part 31. A circular opening 68 in the end wall 362 is centered on the axis 350.

The side wall 364 of the closure 40 has a cylindrical configuration centered on the axis 350. The outer diameter of the side wall 364 of the closure 40 is approximately equal to the inner diameter of the side wall 44 of the diffuser 31. The closure 40 is nested inside the upper housing part 31, as shown in FIG. 3. The side wall 364 of the closure 40 is welded to the side wall 44 of the upper housing part 31 with a single, continuous weld 69.

The inflator 11 includes a first flow control member in the form of a combustor or combustion cup 370. The combustion cup 370 has an annular configuration including a radially extending lower end wall 372 and an axially extending side wall 74. The side wall 74 has an inner side surface 376.

The side wall 74 of the combustion cup 370 is disposed radially inward of the side walls 44 and 364 of the diffuser 31 and closure 40, respectively. The side wall 74 has a ring-shaped upper end surface 80. The upper end surface 80 has a generally frustoconical configuration which seals against the inner side surface 46 of the end wall 42 of the upper housing part 31.

The upper end surface 80 of the combustion cup side wall 74 and the inner side surface 46 of the upper housing part 31 define a fluid passage 90 (FIG. 3) in the inflator 11. Because the combustion cup side wall 74 is cylindrical, the fluid passage 90 has an annular configuration extending around and centered on the axis 350. The fluid passage 90 is located near the fluid outlets 352. The fluid passage 90, which is normally closed, opens upon actuation of the inflator 11, as described below.

The lower end wall 372 of the combustion cup 370 extends radially inward from the lower portion of the side wall 74 of the combustion cup. The lower end wall 372 has an inner side surface 82 which is presented toward the upper housing part 31. The lower end wall 372 has an outer side surface 84 which is in abutting engagement with the inner side surface 366 of the end wall 362 of the closure 40. The axial length of the combustion cup 370 is selected so that the combustion cup is trapped or captured axially between the upper housing part 31 and the closure 40. The lower end wall 372 of the combustion cup 370 also has a ring-shaped end surface 86.

The inflator 11 includes an igniter housing 100. The igniter housing 100 is located centrally in the inflator 11. The igniter housing 100 includes a mounting portion 102, a primary initiator wall 120, a secondary initiator wall 140, and a secondary propellant chamber wall 160.

The mounting portion 102 of the igniter housing 100 is disposed at the lower end of the igniter housing 100. A cylindrical end portion 104 of the mounting portion 102 extends into the circular central opening 68 in the end wall 362 (FIG. 3) of the closure 40. Above the end portion 104, the mounting portion 102 has a radially extending lower side surface 106 which is in engagement with the inner side surface 366 of the closure 40.

The mounting portion 102 has a cylindrical outer side surface 108 that extends upward from the lower side surface 106 and that is in engagement with the cylindrical end surface 86 on the combustion cup 370. A flange 110 of the mounting portion 102 projects radially outward from the upper end of the side surface 108 and overlies the inner side surface 82 of the combustion cup 370. A radially extending upper side surface 112 of the mounting portion 102 defines the upper surface of the flange 110. The end surface 86 of the combustion cup 370 is disposed adjacent to and underlies the flange 110 of the igniter housing 100. The igniter housing 100 helps to locate the combustion cup 370 radially in the inflator 11.

The primary initiator wall 120 of the igniter housing 100 projects axially from the upper side surface 112 of the mounting portion 102. The primary initiator wall 120 has a cylindrical configuration including parallel, axially extending inner and outer side surfaces 122 and 124 (FIG. 4). The primary initiator wall 120 has a radially extending upper end surface 126. The primary initiator wall 120 is not centered on axis 350. Axis 350 extends through the primary initiator wall 120.

The primary initiator wall 120 defines a primary ignition chamber 128. A primary initiator 130 is mounted in the primary ignition chamber 128. The primary initiator 130 is a known device that is electrically actuatable by an electric current applied through terminals 132 to generate combustion products. Specifically, the controller 450 sends an actuation signal to the terminals 132. A sleeve 134 is press fit between the primary initiator 130 and the primary initiator wall 120 to secure the primary initiator in position in the igniter housing 100. The primary ignition chamber 128 and the primary initiator 130 are disposed at a location in the inflator 11 not centered on axis 350.

Multiple ports or passages 136, one of which is shown in FIG. 3, are formed in the primary initiator wall 120, above the primary initiator 130. The passages 136 extend between the primary ignition chamber 128 and the exterior of the igniter housing 100.

The secondary initiator wall 140 (FIGS. 3 and 4) of the igniter housing 100 projects axially from the upper side surface 112 of the mounting portion 102 of the igniter housing 100. The secondary initiator wall 140 has a generally cylindrical configuration extending parallel to axis 350. The secondary initiator wall 140 has an outer side surface 142 (FIG. 4) and a generally annular upper end surface 146 (FIG. 3).

The secondary initiator wall 140 has a portion 144 (FIG. 4) in common with the primary initiator wall 120. The secondary initiator wall 140 is not centered on axis 350. Axis 350 extends through portion 144. The secondary initiator wall 140 defines a secondary ignition chamber 150 (FIG. 4). The center of the secondary ignition chamber 150 and the center of the primary ignition chamber 128 lie on a straight line which extends through axis 350, as is shown in FIG. 4.

A secondary initiator 152 is mounted in the secondary ignition chamber 150. The secondary initiator 152 is a known device that is electrically actuatable by an electric current applied through terminals 154 to generate combustion products. Specifically, the controller 450 sends an actuating signal to the terminals 154 to actuate the secondary initiator 152. A sleeve 156 is press fit between the secondary initiator 152 and the secondary initiator wall 140 to secure the secondary initiator in position in the igniter housing 100.

The secondary propellant chamber wall 160 of the igniter housing 100 extends axially upward from the upper side surface 112 of the mounting portion 102 of the igniter housing. The secondary propellant chamber wall 160 is, throughout most of its circumference, spaced outward from and encloses the secondary initiator wall 140. The secondary propellant chamber wall 160 has parallel, axially extending inner and outer side surfaces 162 and 164 (FIG. 4). The secondary propellant chamber wall 160 has a radially extending upper end surface 166 (FIG. 3).

The secondary propellant chamber wall 160 has a generally kidney-shaped configuration when viewed in plan (from above as viewed in FIG. 3, or as viewed in FIG. 4). The secondary propellant chamber wall 160 includes a cylindrical major portion 168 (FIG. 4) that has a radius of curvature centered on axis 350 and that is spaced farthest from the axis and closest to the side wall 74 of the combustion cup 370. Two minor portions 170 and 172 of the secondary propellant chamber wall 160 have a smaller radius of curvature than the major portion 168. The minor wall portions 170 and 172 curve inward from the ends of the major wall portion 168 and merge into the primary initiator wall 120.

A secondary propellant chamber 180 is defined inside the secondary propellant chamber wall 160. At a location above (as viewed in FIG. 3) the upper surface 146 of the secondary initiator chamber wall 140, an upper portion 182 (FIG. 4) of the secondary propellant chamber 180 has a kidney-shaped configuration. The kidney-shaped configuration includes a cylindrical central portion and two lobes which extend outward from the central portion.

At a location below the upper surface 146 of the secondary initiator chamber wall 140, a lower portion of the secondary propellant chamber 180 has two parts which lie on opposite sides of the secondary initiator wall 140. A floor surface 196 on the mounting portion 102 of the igniter housing 100 is disposed slightly above (as viewed in FIG. 3) the upper major side surface 112. The floor surface 196 comprises two small kidney-shaped portions disposed inside the secondary chamber wall 160 and outside the secondary initiator wall 140. These two surface portions 196 form the bottom of the secondary propellant chamber 180.

A ring-shaped primary propellant chamber or combustion chamber 200 (FIG. 3) is defined inside the combustion cup 370 and outside the igniter housing 100. The radially outer boundary of the primary propellant chamber 200 is the cylindrical inner side surface 376 of the side wall 74 of the combustion cup 370. The radially inner boundary of the primary propellant chamber 200 is formed by the exterior of the igniter housing 100, including the primary initiator chamber wall 120 and the secondary initiator chamber wall 160.

The primary and secondary initiator chamber walls 120 and 160, together, do not have a cylindrical outer surface, and so the primary propellant chamber 200 does not have a strictly annular configuration. Instead, the radial extent, or width, of the primary propellant chamber 200 is different at different points around the chamber, as shown in FIG. 4. Specifically, the radial distance between the combustion cup 370 and the igniter housing 100 is smallest along the cylindrical portion 168 of the secondary propellant chamber wall 160 (to the left as viewed in FIG. 4). The radial distance between the combustion cup 370 and the igniter housing 100 is larger at a diametrically opposite location adjacent the primary initiator chamber wall 120, and is greatest at the two points in between where the primary initiator chamber wall 120 meets the secondary initiator chamber wall 160.

A primary ignition material 210 (FIG. 3) is located in the primary ignition chamber 128, adjacent to and in contact with the primary initiator 130. The primary ignition material 210 is a known material which is ignitable by the primary initiator 130 and which, when ignited, generates combustion products. One suitable material is boron potassium nitrate. A known autoignition material is mixed in with the primary ignition material 210.

A cup-shaped metal igniter cap 220 is disposed in the primary ignition chamber 128 in the igniter housing 100. The igniter cap 220 contains the primary ignition material 210 in the primary ignition chamber 128. The igniter cap 220 has an axially extending, cylindrical side wall 222 which is press fit inside the primary initiator side wall 120 of the igniter housing 100. The igniter cap 220 also has a radially extending end wall 224.

A metal spring cap 230 closes the upper end of the primary ignition chamber 128 in the igniter housing 100. The spring cap 230 is spaced above, as viewed in FIG. 3, the igniter cap 220. The spring cap 230 has an annular, U-shaped side wall 232 which is press fit inside the primary initiator chamber wall 120. The spring cap 100 also has a radially extending central wall 234.

The inflator 11 includes a first actuatable inflation fluid source 240 in the form of a solid propellant. The propellant 240 is located in the primary combustion chamber 200, surrounding the igniter housing 100. The propellant 240 is a known material which is ignitable by the combustion products of the primary ignition material 210 and which, when ignited, produces inflation fluid for inflating the air bag 414. The propellant 240 is illustrated as being provided in the form of a plurality of discs substantially filling the primary propellant chamber 200. The propellant 240 could, alternatively, be provided in the form of small pellets or tablets.

The inflator 11 also includes a second actuatable inflation fluid source 250 in the form of a solid propellant. The secondary propellant 250 is located in the secondary propellant chamber 180. The secondary propellant 250 is a known material which is ignitable by the secondary initiator 152 and which, when ignited, produces inflation fluid for inflating the air bag 414. The secondary propellant 250 may be made from the same material as the primary propellant 240. The secondary propellant 250 is illustrated as being provided in the form of a plurality of small pellets substantially filling the secondary propellant chamber 180. The secondary propellant 250 could, alternatively, be provided in the form of discs or tablets.

A secondary cap 260 closes the upper end of the secondary propellant chamber 180 in the igniter housing 100. The secondary cap 260 has a radially extending central wall 262. The secondary cap 260 has a plurality of tabs 264 which fit inside the secondary combustion chamber wall 160 to hold the cap in place on the igniter housing 100.

The inflator 11 includes a combustor heat sink 270 in the primary combustion chamber 200. The heat sink 270 has an annular configuration extending around the igniter housing 100. The heat sink 270 is formed as a knitted stainless steel wire tube that is compressed to the generally frustoconical shape illustrated in the drawings.

The inflator 11 also includes a perforated metal heat sink retainer 280 that is located in the primary combustion chamber 180. The heat sink retainer 280 is disposed between the heat sink 270 and the fluid passage 90. The heat sink retainer 280 is preferably formed from expanded metal and has a generally frustoconical configuration fitting over the heat sink 270.

The inflator 11 includes a second fluid flow control member in the form of a threshold cap 290. The threshold cap 290 is disposed radially inward of the combustion cup 370, and is located axially between the igniter housing 100 and the diffuser 31. The threshold cap 290 is made from stamped sheet metal, preferably aluminum, substantially thinner than the housing parts 31 and 40.

The threshold cap 290 (FIG. 3) is shaped generally like a throwing disc and has a domed main body portion or central wall 292 centered on the axis 350. The central wall 292 has a circular configuration including an annular outer edge portion 294. The central wall 292 has parallel inner and outer side surfaces 296 and 298.

An annular side wall 300 of the threshold cap 290 extends generally axially from the central wall 292. The side wall 300 of the threshold cap 290 has a plurality of openings in the form of slots 302. The slots 302 are spaced apart by equal distances along the side wall 300 and form a circular array centered on axis 350. The slots 302 collectively define a fluid flow control passage 304 in the threshold cap 290.

The inner side surface 296 of the central wall 292 of the threshold cap 290 is in abutting engagement with the end wall 234 of the spring cap 230. The outer side surface 298 of the central wall 292 of the threshold cap 290 is in abutting engagement with the inner side surface 46 of the end wall 42 of the diffuser 31. The threshold cap 290 extends across the entire primary combustion chamber 200 of the inflator 11. The side wall 300 of the threshold cap 290 is in abutting engagement with the inner side surface 376 of the side wall 74 of the combustion cup 370, near the fluid passage 90. The heat sink retainer 280 is disposed in abutting engagement between the threshold cap 290 and the heat sink 270. The heat sink 270 is disposed in abutting engagement between the heat sink retainer 280 and the primary propellant 240. The heat sink 270 is resilient and cushions the primary propellant 240.

The igniter housing 100 is trapped or captured axially between the threshold cap 290 and the closure 40. Specifically, the distance between the spring cap 230 and the lower side surface 106 of the mounting portion 102 of the igniter housing 100 is selected so that, when the housing parts 31 and 40 are welded together with the igniter housing inside, the end wall 234 of the spring cap resiliently engages the inner side surface 296 of the central wall 292 of the threshold cap 290. The mounting portion 102 of the igniter housing 100 is pressed axially into engagement with the closure 40. The lower end wall 372 of the combustion cup 370 is trapped or captured axially between the flange 110 of the igniter housing 100 and the end wall 362 of the closure 40.

Prior to actuation of the inflator 11, the end surface 80 of the combustion cup side wall 74 seals against the inner side surface 46 of the diffuser end wall 42, so that the fluid passage 90 is closed and has zero flow area. The closed fluid passage 90 blocks fluid flow between the primary combustion chamber 200 and the fluid outlets 352 prior to actuation of the inflator 11. Upon actuation of the inflator 11, as described below, the fluid passage 90 opens to enable inflation fluid to flow between the primary combustion chamber 200 and the fluid outlets 352. The fluid passage 90, when open, has a smaller flow area than the fluid outlets 352 in the diffuser 31.

Prior to actuation of the inflator 11, the control passage 304 in the threshold cap 290 is also in a closed condition. The slots 302 in the threshold cap are covered by the side wall 74 of the combustion cup 370. There is initially no gap between the side wall 300 of the threshold cap 290 and the side wall 74 of the combustion cup 370. The threshold cap 290 substantially blocks fluid flow between the primary combustion chamber 200 and the fluid passage 90. Upon actuation of the inflator 11, the threshold cap 290 moves to enable inflation fluid to flow through the slots 302.

In the event of a vehicle crash at or above the first level of severity, but below the second level of severity, an electric signal is applied to only the terminals 132 of the primary initiator 130. The primary initiator 130 is actuated and ignites the primary ignition material 210. The combustion products of the primary ignition material 210 move the primary initiator cap 230 upward, as viewed in FIG. 3, and flow through the passages 136 into the primary combustion chamber 200.

The combustion products flowing into the primary propellant chamber 200 ignite the primary propellant 240. The primary propellant 240 combusts and produces inflation fluid in the primary propellant chamber 200. The pressure of the inflation fluid in the primary propellant chamber 200 rises rapidly to a pressure in the range of about 1,000 psi to about 2,000 psi or more.

The secondary cap 260 during this time blocks flow of inflation fluid from the primary propellant chamber 200 into the secondary propellant chamber 180. This prevents ignition of the secondary propellant 250 when the primary initiator 130 is actuated but the secondary initiator 152 is not actuated.

The material thickness of the housing 21 is selected so that the end wall 42 of the diffuser 31 deforms from the pressure of the inflation fluid in the primary propellant chamber 200. Specifically, the end wall 42 of the diffuser 31 deforms axially outward, in an upward direction as viewed in FIG. 3.

As the end wall 42 of the diffuser 31 deforms, the fluid passage 90 opens as the end wall 42 moves away from the upper end surface 80 of the combustion cup 370. Fluid pressure also acts on the inner side surface 296 of the threshold cap 290 to move the threshold cap with the diffuser away from the closure 40. At the same time, the heat sink 270 and the heat sink retainer 280 also move with the threshold cap 290 and the diffuser 31 in a direction away from the closure 40. The movement of the threshold cap 290 exposes the slots 302 and opens the control passage 304 to enable inflation fluid to flow out of the primary propellant chamber 200 through the fluid passage 90.

The heat sink 270 cools and filters the inflation fluid flowing out of the primary propellant chamber 200. The heat sink 270 also filters particulate matter out of the inflation fluid. The heat sink retainer 280 prevents the material of the heat sink 270 from being forced into the slots 302 of the threshold cap 290 by the rapidly flowing inflation fluid. Inflation fluid flows an annular final filter 310 prior to exiting the inflator 11 through the inflation fluid outlets 352.

The flow area of the fluid passage 90 in the housing 21 varies in accordance with the pressure of inflation fluid in the housing 21. Specifically, the higher the pressure in the housing 21, the larger the flow area of the fluid passage 90.

Since the fluid passage 90 has a 360 degree circumferential extent and the slots 302 have a limited circumferential extent, the flow area of the fluid passage 90 increases more rapidly than the flow area of the control passage 304. Thus, the fluid flow area through the slots 302 in the threshold cap 290 almost immediately becomes smaller than the fluid flow area through the fluid passage 90 between the combustion cup 370 and the diffuser 31. Thus, the threshold cap 290 acts as a restrictor for controlling the rate of fluid flow out of the inflator 11.

In the event of a vehicle crash at or above the second level of severity, both the primary initiator 130 and the secondary initiator 152 are actuated. The actuation of the primary initiator 130 results in ignition of the primary propellant 240 as described above. Inflation fluid produced by the primary propellant 240 deforms the housing 21, moves the threshold cap 290, and flows out of the inflator 11 as described above.

The secondary initiator 152 is actuated by an electric signal applied to the terminals 154 of the secondary initiator. The secondary initiator 152 ignites the secondary propellant 250. The secondary propellant 250 produces combustion products which increase the pressure in the secondary combustion chamber 180. This increased pressure acts on the secondary igniter cap 260 and causes the secondary igniter cap to move out of engagement with the igniter housing 100.

The combustion products of the secondary propellant 250 join with the combustion products of the primary propellant 240 in the primary combustion chamber 200. The resulting increase in pressure in the primary combustion chamber 200 causes the housing 21 to deform more than it does when only the primary propellant 240 is ignited. This increased deformation of the housing 21 also allows more movement of the threshold cap 290 and thus more exposure of the slots 302. As a result, the flow area of the control passage 304 increases.

The combined combustion products of the secondary propellant 250 and the primary propellant 240 flow into the heat sink 270. The heat sink 270 cools and filters the combustion products of the secondary propellant 250. The inflation fluid flowing out of the heat sink 270 flows through the slots 302 in the threshold cap 290 and thence out of the inflator 11 in the manner described above.

The vehicle occupant restraint system 13 of FIG. 3 also includes a delay circuit 451, such as a solid state time delay circuit or any other known time delay circuit or device. The delay circuit 451 is electrically coupled to the controller 450. Alternatively, the delay circuit 451 may form a portion of the controller 450. A position sensor 470 and a temperature sensor 472 are electrically coupled to the delay circuit 451.

The position sensor 470 senses the position of a seat relative to the part of the vehicle in which the air bag 414 is stored and provides a position signal to the delay circuit 451. The position of the seat affects the position of an occupant of the seat relative to the air bag 414. Therefore, the position signal provided to the controller 450 by the position sensor 470 is also indicative of the position of an occupant of the seat relative to the air bag 414.

The temperature sensor 472 senses the ambient temperature at the inflator 11, and provides a temperature signal indicative of the ambient temperature to the delay circuit 451. The ambient temperature at the inflator 11 affects the rate at which the propellants 240, 250 will burn and generate gas for inflating the air bag 414. This rate generally increases as the ambient temperature rises.

The delay circuit 451 is responsive to the temperature signal and the pressure signal for delaying actuation of second propellant 250 for a predetermined time period after actuation of the first propellant 240. Preferably, the predetermined time period of the delay is 10 milliseconds+(1 millisecond/(Inflator ambient temperature in degree centigrade −22° C.)) for inflator ambient temperatures above 22° C. For temperatures less than or equal to 22° C., the predetermined time period of the delay will be 10 milliseconds. Thus, increasing the delay when the ambient temperature increases above 22° C. counteracts the increase in the rate of inflation of the air bag 414 due to the rise in ambient temperature. The delay circuit 451 is responsive to the position sensor 470 for modifying time period of the delay. For example, if the position of the occupant of the seat is indicated to be relatively close to the air bag 414, it may be desirable to increase the delay to inflate the air bag 414 relatively slowly to provide a relatively “soft” inflation of the air bag. The delay circuit 451 can also be responsive to other sensors such as those that determine the size and weight of an occupant for modifying the time period of the delay. The time period of the delay between the first and second propellants 240, 250 does not exceed 30 milliseconds. The second propellant 250 is always activated within 100 milliseconds after the occurrence of the vehicle collision to prevent inadvertent activation of the second source 250 long after the occurrence of the vehicle collision.

From the above description of the invention, those skilled in the art will perceive improvements, changes and modifications. For example, the inflator could include a greater or lesser number of sources of inflation fluid, with the number of differing volumes of inflation fluid being determined accordingly. The inflator could also include different types of sources of inflation fluid, such as hybrid or augmented inflators having containers of pressurized inflation fluid. Such improvements, changes and modifications within the skill of the art are intended to be covered by the appended claims.

Having described the invention, the following is: claimed:

1. An apparatus for inflating an air bag comprising:
a first source of inflation fluid actuatable to produce a first volume of inflation fluid;
a second source of inflation fluid actuatable to produce a second volume of inflation fluid which differs from said first volume;
a temperature sensor for providing a temperature signal indicative of the temperature of the apparatus;
a control system operatively connected to the temperature sensor, said control system actuating said first and second sources of inflation fluid; and
a delay circuit coupled to said temperature sensor and said control system, said delay circuit being responsive to the temperature signal for delaying the actuation of one of said first and second sources for a predetermined period of time after actuation of said other one of said first and second sources.

2. The apparatus of claim 1 wherein the predetermined period of time of the delay equals 10 milliseconds+(1 millisecond/(Inflator ambient temperature degree centigrade −22° C.)) for inflator ambient temperatures above 22° C.

3. The apparatus of claim 1 including a sensor device for sensing a condition and providing a control signal indicative of the condition, said sensor device coupled to said delay circuit for modifying the period of time of the delay based on said control signal.

4. The apparatus of claim 3 wherein said sensor device is a position sensor for providing a position signal indicative of the position of an occupant of a vehicle, said position sensor coupled to said delay circuit for modifying the period of time of the delay based on said position signal.

5. The apparatus of claim 4 wherein said position sensor senses a position of the occupant by sensing a relative position of a seat within the vehicle.

6. The apparatus of claim 1 wherein both of said first and second sources are actuated within 100 milliseconds after an occurrence of a collision of a vehicle containing the apparatus.

7. The apparatus of claim 1 wherein the predetermine period of time of the delay does not exceed 30 milliseconds.

8. An apparatus for inflating an air bag comprising:
a first source of inflation fluid actuatable to produce a volume of inflation fluid;
a second source of inflation fluid actuatable to produce a volume of inflation fluid;
a temperature sensor for providing a temperature signal indicative of the temperature of the apparatus;
a control system operatively connected to the temperature sensor, said control system actuating said first and second sources of inflation fluid; and
a delay circuit coupled to said temperature sensor and said control system, said delay circuit delaying the actuation of one of said first and second sources for a predetermined period of time after actuation of said other one of said first and second sources based on the temperature signal;
wherein the predetermined period of time equals 10 milliseconds+(1 millisecond/(Inflator ambient temperature degree centigrade −22° C.)) for inflator ambient temperatures above 22° C.

9. The apparatus of claim 8 including a sensor device for sensing a condition and providing a control signal indicative of the condition, said sensor device coupled to said delay circuit for modifying the period of time of the delay based on said control signal.

10. The apparatus of claim 9 wherein said sensor device is a position sensor for providing a position signal indicative of the position of an occupant of a vehicle, said position sensor coupled to said delay circuit for modifying the period of time of the delay based on said position signal.

11. The apparatus of claim 10 wherein said position sensor senses a position of the occupant by sensing a relative position of a seat within the vehicle.

12. The apparatus of claim 8 wherein both of said first and second sources are actuated within 100 milliseconds after an occurrence of a collision of a vehicle containing the apparatus.

13. The apparatus of claim 8 wherein the predetermine period of time of the delay does not exceed 30 milliseconds.
